(19) United States
(12) Patent Application Publication
(10) Pub. No.: US 2020/0060253 A1
(43) Pub. Date: Feb. 27, 2020

(54) Insect Capturing Assembly

(71) Applicants: William Stokes, Mt. Pleasant, TN (US); Crystal Stokes, Mt. Pleasant, TN (US)

(72) Inventors: William Stokes, Mt. Pleasant, TN (US); Crystal Stokes, Mt. Pleasant, TN (US)

(21) Appl. No.: 16/108,342

(22) Filed: Aug. 22, 2018

(51) Int. Cl. A01M 3/00

(52) U.S. Cl. CPC A01M 3/00

(57) ABSTRACT

An insect capturing assembly for capturing insects on a ceiling includes a pole that can be gripped and directed upwardly toward a ceiling. A bottle is removably coupled to the pole such that the bottle is positioned adjacent to the ceiling when the pole is directed upwardly toward the ceiling. The bottle is oriented collinear with the pole such that an opening in the bottle is directed toward the ceiling. Thus, the opening can surround an insect on the ceiling thereby facilitating the bottle to capture the insect. The bottle has a division therein to define a top half of the bottle that is removably coupled to a bottom half of the bottle, and the top half is removable from the pole for emptying the bottom half.

### CROSS-REFERENCE TO RELATED APPLICATIONS

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art including information disclosed under 37 CFR 1.97 and 1.98.

The disclosure and prior art relates to capturing devices and more particularly pertains to a new capturing device for capturing insects on a ceiling.

### BRIEF SUMMARY OF THE INVENTION

An embodiment of the disclosure meets the needs presented above by generally comprising a pole that can be gripped and directed upwardly toward a ceiling. A bottle is removably coupled to the pole such that the bottle is positioned adjacent to the ceiling when the pole is directed upwardly toward the ceiling. The bottle is oriented collinear with the pole such that an opening in the bottle is directed toward the ceiling. Thus, the opening can surround an insect on the ceiling thereby facilitating the bottle to capture the insect. The bottle has a division therein to define a top half of the bottle that is removably coupled to a bottom half of the bottle, and the top half is removable from the pole for emptying the bottom half.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of an insect capturing assembly according to an embodiment of the disclosure.

FIG. 2 is a right side exploded view of an embodiment of the disclosure.

FIG. 3 is a cross sectional view taken along line 3-3 of FIG. 1 of an embodiment of the disclosure.

FIG. 4 is a back phantom view of an embodiment of the disclosure.

FIG. 5 is a perspective in-use view of an embodiment of the disclosure.

### DETAILED DESCRIPTION OF THE INVENTION

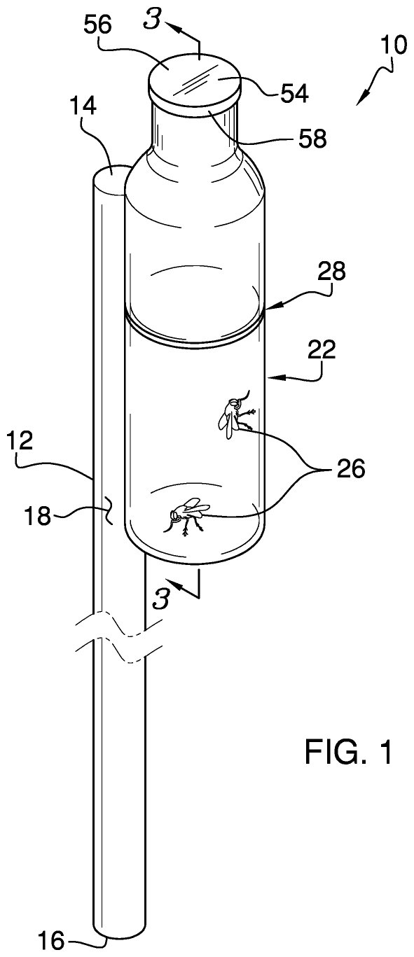

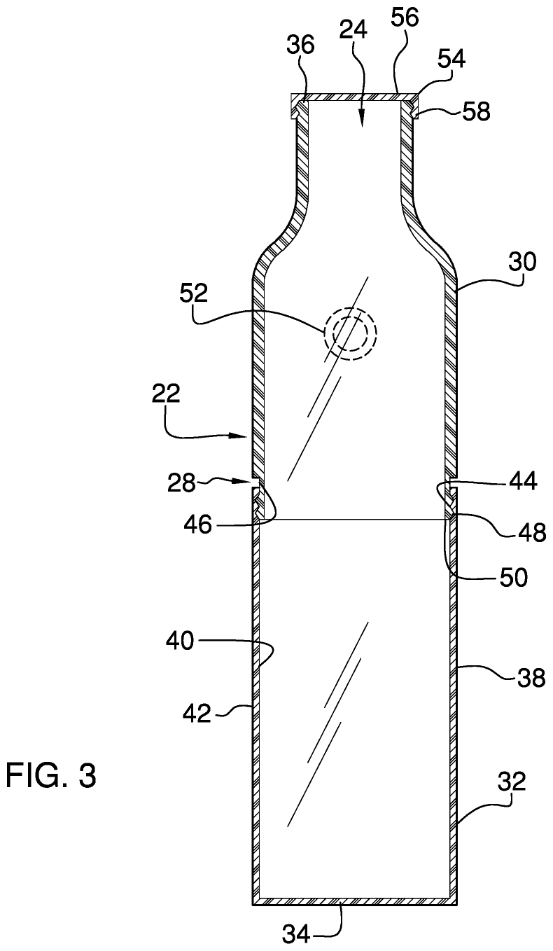

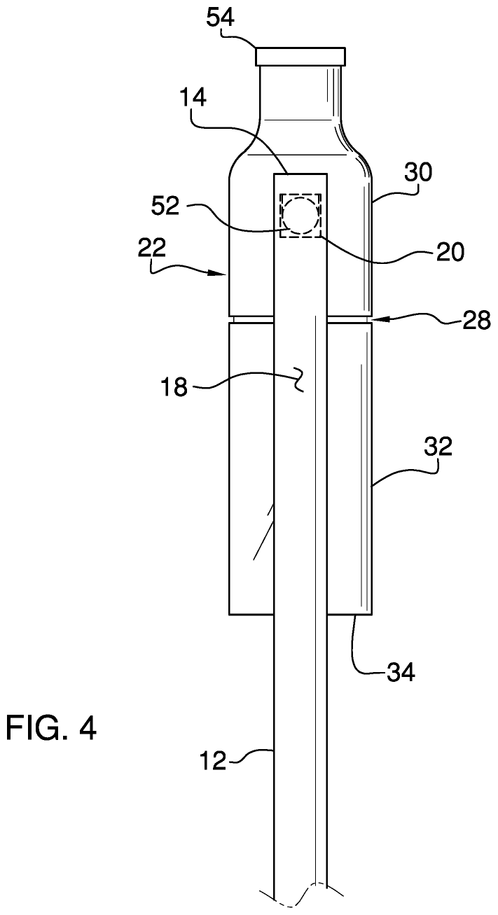

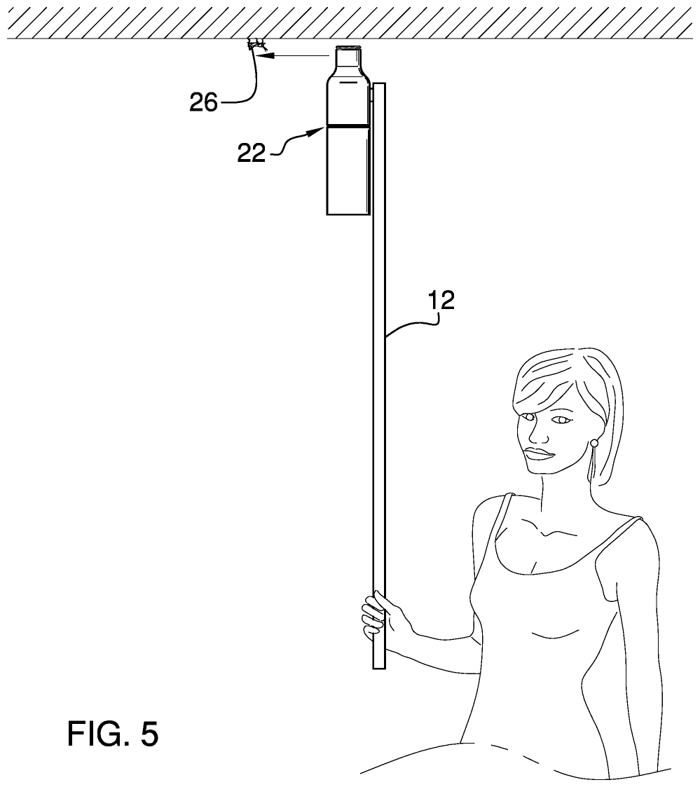

With reference now to the drawings, and in particular to FIGS. 1 through 5 thereof, a new capturing device embodying the principles and concepts of an embodiment of the disclosure and generally designated by the reference numeral 10 will be described.

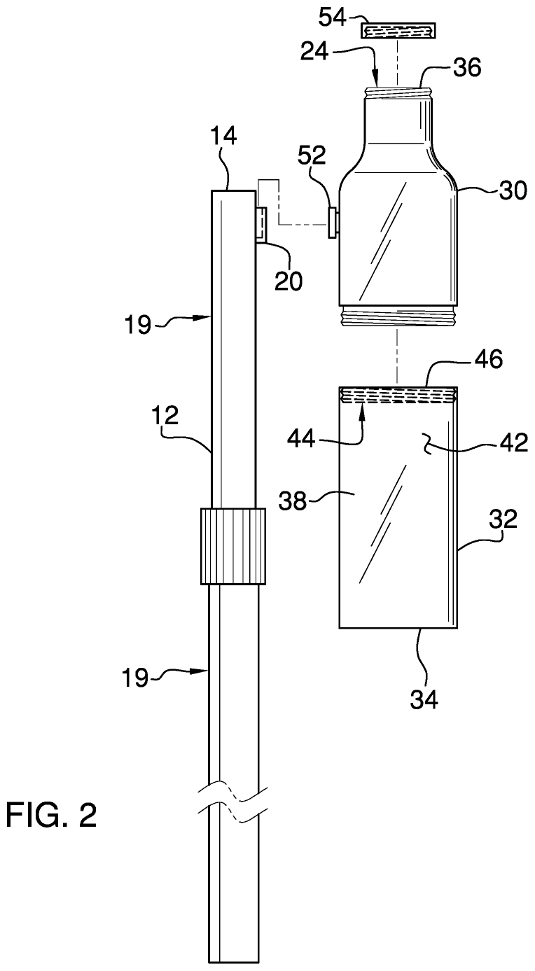

As best illustrated in FIGS. 1 through 5, the insect capturing assembly 10 generally comprises a pole 12 that is gripped and directed upwardly toward a ceiling 13. The pole 12 has a first end 14, a second end 16 and an outer surface 18 extending therebetween. The ceiling 13 may be a ceiling 13 in a room in a house, an office or any other room in any type of structure. Additionally, the pole 12 may have a length of at least 90.0 cm thereby facilitating the pole 12 to reach the ceiling 13 without requiring a user to climb a stool or ladder. As shown in FIG. 2, the pole 12 may have a pair of slidable sections 19 such that the pole 12 has a telescopically adjustable length. A receiver 20 is coupled to the outer surface 18 of the pole 12 and the receiver 20 is positioned closer to the first end 14 than the second end 16. The receiver 20 may be a mechanical receiver of any conventional design that can slidably receive an engagement 52.

A bottle 22 is removably coupled to the pole 12 such that the bottle 22 is positioned adjacent to the ceiling 13 when the pole 12 is directed upwardly toward the ceiling 13. The bottle 22 is oriented collinear with the pole 12 such that an opening 24 in the bottle 22 is directed toward the ceiling 13. In this way the opening 24 can surround an insect 26 on the ceiling 13 thereby facilitating the bottle 22 to capture the insect 26. The insect 26 may be a crawling insect such as a ladybug, an ant or any other crawling insect commonly found on a ceiling 13. The bottle 22 has a division 28 therein to define a top half 30 of the bottle 22 that is removably coupled to a bottom half 32 of the bottle 22, and the top half 30 is removable from the pole 12 for emptying the bottom half 32.

The bottle 22 has a bottom end 34, a top end 36 and an outer wall 38 extending therebetween. The outer wall 38 curves inwardly adjacent to the top end 36 and the opening 24 extends through the top end 36. The division 28 extends through the outer wall 38, the division 28 extends around an entire circumference of the outer wall 38 and the division 28 is positioned between the top 32 and bottom 34 ends. The outer wall 38 has an inside surface 40 and an outside surface 42. The inside surface 40 of the bottom half 32 has a threaded section 44 adjacent to an upper threshold 46 of the bottom half 32. Additionally, the outside surface 42 of the top half 30 has a threaded section 48 adjacent to a lower threshold 50 of the top half 30. The threaded section 44 on the top half 30 threadably engages the threaded section 48 on the bottom half 32.

An engagement 52 is coupled to and extends outwardly from the outer wall 38 of the bottle 22 and the engagement 52 is positioned on the top half 30 of the bottle 22. The receiver 20 slidably receives the engagement 52 to releasably couple the bottle 22 to the pole 12. The engagement 52 may be a peg, a tab and any other type of protrusion that can slidably engage the receiver 20. A cap 54 is removably positioned on the bottle 22 for closing the bottle 22 to inhibit the insect 26 from escaping the bottle 22, and the cap 54 has a top wall 56 and a perimeter wall 58 extending downwardly therefrom. The perimeter wall 58 threadably engaging the outer wall 38 of the bottle 22 has the top wall 56 lying on the top end 36 of the bottle 22 thereby closing the opening 24 in the top end 36.

In use, the engagement 52 is inserted into the receiver 20 the couple the bottle 22 to the pole 12 and the pole 12 is gripped to position to top end 36 of the bottle 22 around the insect 26 on the ceiling 13. The pole 12 can be wiggled back and forth to knock the insect 26 off of the ceiling 13 if the insect 26 does not fall into the bottle 22. Thus, the bottle 22 captures the insect 26 without requiring the user to climb a ladder or to physically touch the insect 26. The process of capturing the insect 26 can be repeated multiple time until the bottle 22 is full of insects. The top half 30 of the bottle 22 is removable from the bottom half 32 of the bottle 22 at any time to empty the insects from the bottle 22. Additionally, the cap 54 can be positioned on the bottle 22 at any time to retain the insects in the bottle 22.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An insect capturing assembly being configured to capture insects on a ceiling, said assembly comprising:
a pole being gripped and directed upwardly toward a ceiling; and
a bottle being removably coupled to said pole such that said bottle is positioned adjacent to the ceiling when said pole is directed upwardly toward the ceiling, said bottle being oriented collinear with said pole such that an opening in said bottle is directed toward the ceiling wherein said opening is configured to surround an insect on the ceiling thereby facilitating said bottle to capture the insect, said bottle having a division therein to define a top half of said bottle being removably coupled to a bottom half of said bottle, said top half being removable from said pole for emptying said bottom half.

2. The assembly according to claim 1, further comprising:
said pole having a first end, a second end and an outer surface extending therebetween; and
a receiver being coupled to said outer surface of said pole, said receiver being positioned closer to said first end than said second end.

3. The assembly according to claim 1, wherein:
said bottle has a bottom end, a top end and an outer wall extending therebetween, said outer wall curving inwardly adjacent to said top end, said opening extending through said top end, said division extending through said outer wall, said division extending around an entire circumference of said outer wall, said division being positioned between said top and bottom ends; and
said outer wall having an inside surface and an outside surface, said inside surface of said bottom half having a threaded section adjacent to an upper threshold of said bottom half, said outside surface of said top half having a threaded section adjacent to a lower threshold of said top half, said threaded section on said top half threadably engaging said threaded section on said bottom half.

4. The assembly according to claim 2, further comprising:
said bottle having an outer wall and a top half; and
an engagement being coupled to and extending outwardly from said outer wall of said bottle, said engagement being positioned on said top half of said bottle, said receiver slidably receiving said engagement to releasably couple said bottle to said pole.

5. The assembly according to claim 3, further comprising a cap being removably positioned on said bottle for closing said bottle wherein said cap is configured to inhibit the insect from escaping said bottle, said cap having a top wall and a perimeter wall extending downwardly therefrom, said perimeter wall threadably engaging said outer wall of said bottle having said top wall lying on said top end of said bottle thereby closing said opening in said top end.

6. An insect capturing assembly being configured to capture insects on a ceiling, said assembly comprising:
a pole being gripped and directed upwardly toward a ceiling, said pole having a first end, a second end and an outer surface extending therebetween;
a receiver being coupled to said outer surface of said pole, said receiver being positioned closer to said first end than said second end;
a bottle being removably coupled to said pole such that said bottle is positioned adjacent to the ceiling when said pole is directed upwardly toward the ceiling, said bottle being oriented collinear with said pole such that an opening in said bottle is directed toward the ceiling wherein said opening is configured to surround an insect on the ceiling thereby facilitating said bottle to capture the insect, said bottle having a division therein to define a top half of said bottle being removably coupled to a bottom half of said bottle, said top half being removable from said pole for emptying said bottom half, said bottle having a bottom end, a top end and an outer wall extending therebetween, said outer wall curving inwardly adjacent to said top end, said opening extending through said top end, said division extending through said outer wall, said division extending around an entire circumference of said outer wall, said division being positioned between said top and bottom ends, said outer wall having an inside surface and an outside surface, said inside surface of said bottom half having a threaded section adjacent to an upper threshold of said bottom half, said outside surface of said top half having a threaded section adjacent to a lower threshold of said top half, said threaded section on said top half threadably engaging said threaded section on said bottom half;
an engagement being coupled to and extending outwardly from said outer wall of said bottle, said engagement being positioned on said top half of said bottle, said receiver slidably receiving said engagement to releasably couple said bottle to said pole; and
a cap being removably positioned on said bottle for closing said bottle wherein said cap is configured to inhibit the insect from escaping said bottle, said cap having a top wall and a perimeter wall extending downwardly therefrom, said perimeter wall threadably engaging said outer wall of said bottle having said top wall lying on said top end of said bottle thereby closing said opening in said top end.
